(19) United States
(12) Patent Application Publication
(10) Pub. No.: US 2024/0185260 A1
(43) Pub. Date: Jun. 6, 2024

(54) SYSTEMS AND METHODS FOR CREATING A NON-FUNGIBLE TOKEN ASSOCIATED WITH A COLLECTIBLE

(71) Applicant: Ultra PRO International LLC, Commerce, CA (US)

(72) Inventor: Chen (Jay) Kuo, Irvine, CA (US)

(73) Assignee: Ultra PRO International LLC, Commerce, CA (US)

(21) Appl. No.: 18/074,400

(22) Filed: Dec. 2, 2022

(51) Int. Cl. G06Q 30/018; G06F 16/27; H04N 5/77

(52) U.S. Cl. CPC G06Q 30/018; G06F 16/27; H04N 5/77

(57) ABSTRACT

A system for creating a non-fungible token associated with a collectible and grading of the collectible is disclosed. In one embodiment, the system may comprise: an image capture device; and a non-fungible token minting device. In some embodiments, the system may be configured to: receive a collectible and deliver the collectible to a grader that performs a grading procedure on the collectible; record the grader during the grading procedure, via the image capture device, and produce an image file; and mint a non-fungible token, via the non-fungible token minting device, based on the image file and associate the non-fungible token with the collectible.

### FIELD OF DISCLOSURE

This invention relates generally to systems and methods for creating a non-fungible token associated with a collectible. In particular, systems and methods are described herein for creating a non-fungible token associated with a collectible and grading of the collectible.

### BACKGROUND

Collectibles are often graded by professional grading companies, or individuals, to provide assurances to owners, purchasers, and sellers of the condition for a collectible. The current grading services offered by most major grading companies for the grading of collectibles, such as trading cards (i.e. sports cards such as baseball cards, football cards, basketball cards, hockey cards, soccer cards, or gaming cards such as Pokémon® cards, Magic the Gathering® cards, etc.) and the like, follow a common set of steps. An individual submits a collectible to the grading company (typically by mail, or by in-person drop-off), the grading company assigns a grader to examine the collectible and the grader assigns a rating based on their review of the collectible.

The grading company will then encapsulate the collectible, typically in a plastic shell, that offers some physical tamper-proof features, and then the grading company mails the encapsulated collectible back to the individual who submitted it or arranges for an in-person pickup of the now graded collectible.

The current grading services have many drawbacks. For one thing, the grading process can vary from grading company to grading company and there exists a lack of transparency for the act of grading. One reason for the variation in the grading process is that is almost always a manual process performed by human beings who introduce variation into the process. Similarly, collectors may not always have the highest degree of confidence in grading outcomes as well as whether a previous act of grading is still valid. To this point, collectors do not always have the highest assurance as to the condition of a collectible at the time of submission for grading to verify good physical safekeeping of the item.

What is needed is a solution that can provide a greater amount of transparency into the grading process as well as a technical solution that delivers that transparency and increases collectors' confidence in a grading system.

### DESCRIPTION OF DRAWINGS

The figures described below depict various embodiments, features, and aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary system for creating a non-fungible token associated with a collectible and grading of the collectible.

FIG. 2 depicts an exemplary server configured to create a non-fungible token associated with a collectible and grading of the collectible.

FIG. 3 depicts an exemplary system for creating a non-fungible token associated with a collectible and grading of the collectible.

FIG. 4 depicts an exemplary non-fungible minting component for creating a non-fungible token associated with a collectible and grading of the collectible.

FIG. 5 depicts an exemplary storage solution for a non-fungible token associated with a collectible and grading of the collectible.

FIG. 6 depicts an exemplary method for creating a non-fungible token associated with a collectible and grading of the collectible.

The figures depict aspects of the present embodiments for purposes of illustration only. One skilled in the art will readily recognize from the following discussion that alternate aspects of the structures and methods illustrated herein may be employed without departing from the principles of the invention described herein.

### DETAILED DESCRIPTION OF THE INVENTION

The present disclosure relates generally to systems and methods for providing a technical solution to many of the problems involved in the collecting industry with respect to the grading of collectibles. For example, by employing the systems and methods described herein a grading service may increase transparency into the act of grading thereby increasing the degree of confidence in grading outcomes amongst the collecting community. Additionally, a consequence of grading services utilizing the systems and methods described herein is that the collecting community would gain higher assurances as to the condition of a collectible at the time of submission for grading as well as during the grading process. As such, with these improvements in the reliability and verifiability of grading of collectibles any particular collectible market will have greater transparency as to the physical conditions of collectibles which will lead to more accurate pricing and confidence in the items that are traded in that market. This will reduce inefficiencies that come from being unable to verify the grading process in detail as well as the need for additional grading that purchasers may wish to buy to verify that grading of a collectible is accurate. These benefits will be apparent to grading services, collectors, sellers, purchasers, as well as observers of collectible markets that benefit from grading services employing the systems and methods described herein.

As stated herein, the present disclosure relates generally to systems and methods for creating a non-fungible token associated with a collectible and grading of the collectible. In one embodiment, the system may comprise: an image capture device; and a non-fungible token minting device. In some embodiments, the system may be configured to: receive a collectible and deliver the collectible to a grader that performs a grading procedure on the collectible; record the grader during the grading procedure, via the image capture device, and produce an image file; and mint a non-fungible token, via the non-fungible token minting device, based on the image file and associate the non-fungible token with the collectible.

Put another way, the systems and methods described herein allow an individual or service provider to create a record of the grading process of a collectible that is associated with a NFT. The present disclosure provides a technical solution that delivers greater transparency and increases collectors' confidence in a grading system as well as the grade associated with a collectible.

A non-fungible token, or NFT, is a unique piece of data that may be stored on a decentralized ledger such as a blockchain. The NFT exists as an entry in a smart contract that is itself an entry on a decentralized ledger such as a blockchain. The NFT may have certain functionality that is enabled via functions that take input, potentially manipulate the input, and output according to a set of instructions. There may be metadata associated with the NFT such as, but not limited to, a name for the NFT, a description of the NFT, a link to at least one media file (e.g. still image, video stream, audio/visual, or audio) that is associated with the NFT, and a set of attributes for the NFT. The NFT may be associated with physical items as well as digital items. There may also be metadata associated with the grading process, the grading company, and other relevant data. The NFT may function as a certificate of authenticity or proof of ownership.

In one embodiment, a collector may submit their collectible to a grading company (typically by mail, or by in-person drop-off), and the grading company assigns a grader to examine the collectible and assign a rating based on their review. This review process may be recorded as an image or video file that includes a high-resolution scan of the collectible and a recording of the grading activity.

At this point, the grading company may mint the video file as a NFT and ownership of the NFT may be delivered to the collector that submitted the collectible for grading. Ownership may take the form of transferring control over a public-private key pair associated with the NFT itself, or may take the form of control over an account that represents a claim on the NFT which is itself managed by a third party. As part of the minting process the grading company may allow a collector to add metadata to the NFT that includes characteristics about the collectible (e.g. rarity, condition, physical specifications, etc.) as well as the NFT itself (e.g. whether the NFT has rewards associated with it, a royalty stream for licensing purposes, unlockable content, or other special perks that allows for membership in online or offline communities). The grading company may directly mint the NFT themselves by utilizing a mint function for the smart contract associated with the NFT by sending an amount of cryptocurrency to cover the cost of minting on the underlying blockchain as well as the number of NFTs to create during the minting process. Alternatively, the grading company may utilize a “lazy minting” process that includes sending the video file and metadata related to the collectible and the NFT to a third party service provider that allows for a buyer of the collectible to mint the NFT as the time of purchase.

The collector is then able to provide the NFT and associated video file as a tamper evident piece of evidence showcasing the grading process that a potential purchaser can verify on their own by checking the NFT and associated video file. One aspect of “checking” the NFT is verifying that the NFT is associated with the collectible and the associated video file. The grading company may then encapsulate the collectible, for example in a plastic shell, that offers some physical tamper-proof features that allow a collector, or purchaser, to know if the casing surrounding the capsule has been tampered with. As such, regardless of if the grading company has encapsulated the collectible or not, the grading company may then mail the collectible back to the individual that submitted the collectible, or arrange for an in-person pickup of the collectible.

To reiterate, because of the technical solution implemented by the systems and methods disclosed herein certain benefits are afforded to owners, purchasers, and sellers of collectibles as well as the collectible marketplace as a whole. For example, some benefits of the present disclosure may include: bringing transparency to the act of grading of a collectible; providing security on the assigned grade by hosting the video files on a read-only server; showing the condition of the collectible at the time of submission to verify good physical safekeeping of the item; proof of ownership of collectibles; recording transaction history to show ownership record of the collectible; and recording transaction price history as an indicator of current market value for the collectible. These benefits above ultimately increase confidence in the ownership, authenticity, and condition of the collectible, which may lead to higher secondary market prices for collectibles in general.

Individuals and grading companies that implement the systems and methods disclosed herein may be incentivized to perform the functionality described herein by receiving compensation for: grading the collectible; create the video, or other recording file of the grading process; hosting the video, or other type of recording, file in a secured fashion; minting a NFT with the video, or other type of recording, file; and encapsulating the collectible, potentially in such a way that the collectible has a physical code/QR code that points back to the NFT associated with the collectible.

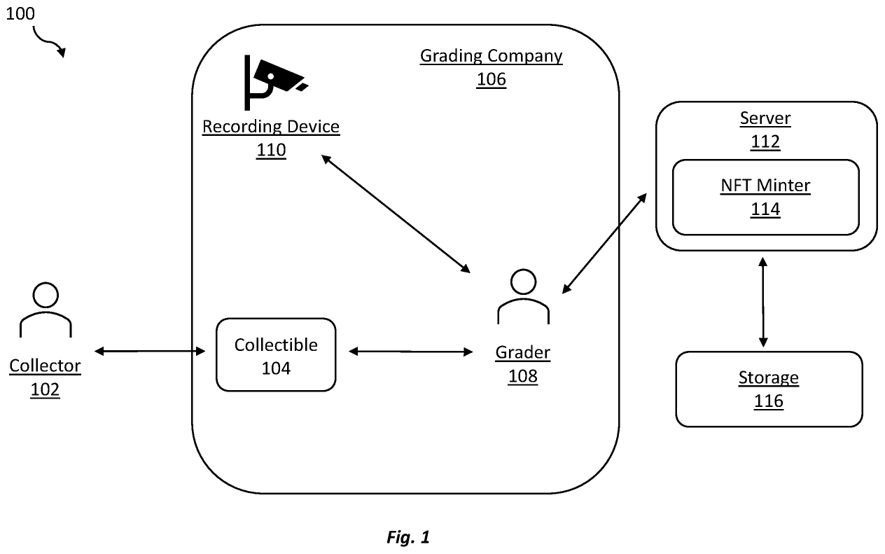

FIG. 1 depicts an exemplary system 100 for creating a non-fungible token associated with a collectible and grading of the collectible. The system 100 may include a collector 102, a collectible 104, a grading company 106, a grader 108, a recording device 110, a server 112, a NFT minter 114, and storage 116. In some embodiments there may be more or fewer components than those shown. The grading company 106, recording device 110, server 112, and storage 116 may all be communicatively coupled together allowing them to exchange information as needed to perform the functionality described herein.

The collector 102 may be an individual, or organization, that owns the collectible 104. The collectible may be an individual trading card, gaming card, figurine, coin, pin, wearable item such as a hat or broch, stamp, book, comic book, magazine, post card, picture, nick knack, bric-a-brac, tchotchke, or another collectible item. In some embodiments, the collectible 104 may be a set of the aforementioned collectibles.

The grading company 106 may be a service provider that performs the service of grading the collectible 104 for the collector 102. The grading company 106 may have a proprietary method of grading performed by the grader 108 who performs the act of grading on the collectible 104.

The recording device 110 may be a piece of equipment that is owned and operated by the grading company 106 to record the act of grading done by the grader 108 of the collectible. 104. The recording device 110 may be an audio recording device, a video recording device (that may also record audio while recording video), a camera, and a stereoscopy recording device. In some embodiments, the recording device 110 may be activated by the grading company 106, the grader 108, or automatically activated via motion, or sound in a particular area located at a site owned by the grading company 106.

The server 112 may be accessed by the grader 108 utilizing a computing device (not shown) as part of the grading process, or once the grading process is complete to access the NFT minter 114. The NFT minter 114 may be located on a server 112 that is controlled by an organization that offers NFT minting services for free or at a cost that is utilized by the grading company 106. As part of the NFT minting process, the NFT minter 114 may communicate with storage 116 where the NFT, any recording of the NFT grading process, metadata about the NFT, metadata about the NFT grading process, and/or a digital version of the collectible may be stored. In some embodiments, the server 112 may be controlled by the grading company 106 and consequently the NFT minter 114 is also controlled by the grading company 106.

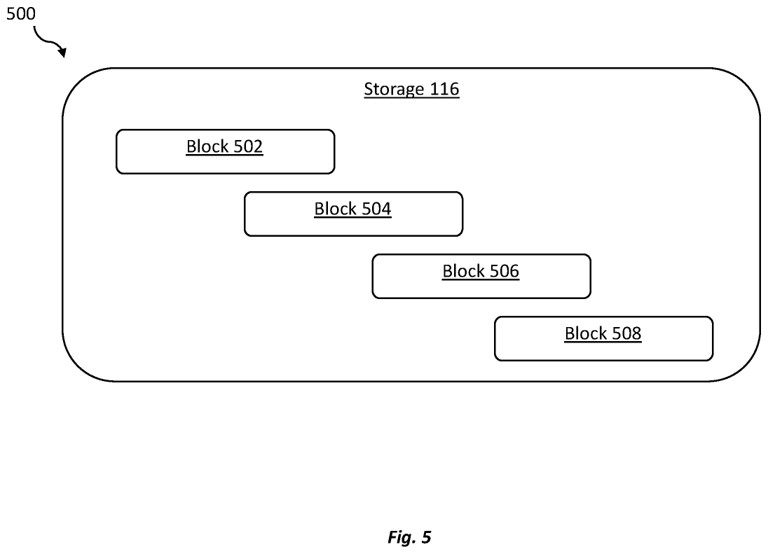

The storage 116 may be a server that has memory where it stores the above listed data associated with the NFT and the grading process, or a decentralized storage solution such as a decentralized ledger based storage system such as the decentralized storage solution depicted in FIG. 5 described below.

In one embodiment of the system 100 depicted in FIG. 1, the system may comprise an image capture device, and a non-fungible token minting device. The system 100 may be configured to: receive a collectible and deliver the collectible to a grader that performs a grading procedure on the collectible; record the grader during the grading procedure, via the image capture device, and produce an image file, and mint a non-fungible token, via the non-fungible token minting device, based on the image file and associate the non-fungible token with the collectible.

In some embodiments of the system the image capture device may be a video recording device. The video recording device may capture both video and audio. Similarly, in some embodiments the image file may comprise a video stream, which may be a series of still images played in sequence. In some embodiments of the system the collectible may be a physical item, or a digital item. Further, the system may be further configured to store, at a decentralized ledger, the image file associated with the non-fungible token.

Similarly, the system may further comprise a server, wherein the server is configured to store the image file associated with the non-fungible token. In other embodiments the non-fungible token is stored on a decentralized ledger, or a server, as part of the minting process.

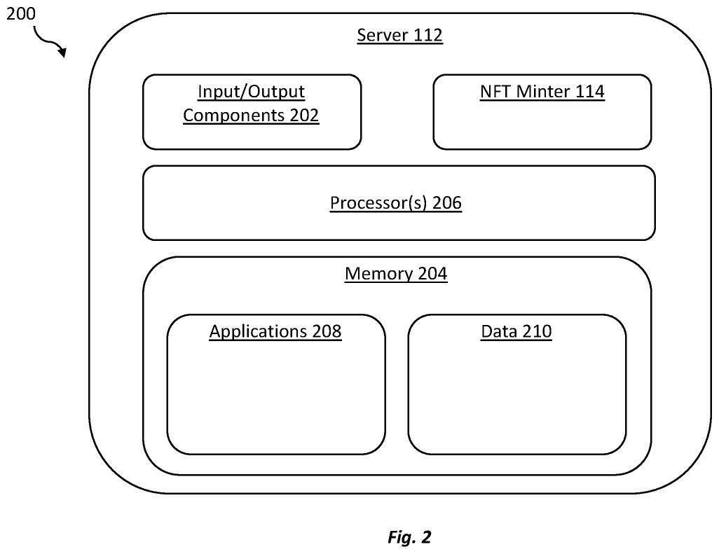

FIG. 2 depicts an exemplary server 112 configured to create a non-fungible token associated with a collectible and grading of the collectible. The server may comprise input/output components 202 for exchanging data, memory 204 for storing and accessing data, processors 206 for executing operations related to data, applications 208 for providing functionality for individuals or computing devices that interact with the server 112, and the storage of data 210 in the memory 204 for storing data relevant to the functionality described herein. The server 112 in some embodiments may have more or fewer components. The server 112 may be configured to provide the functionality described in FIGS. 1, and 3-5.

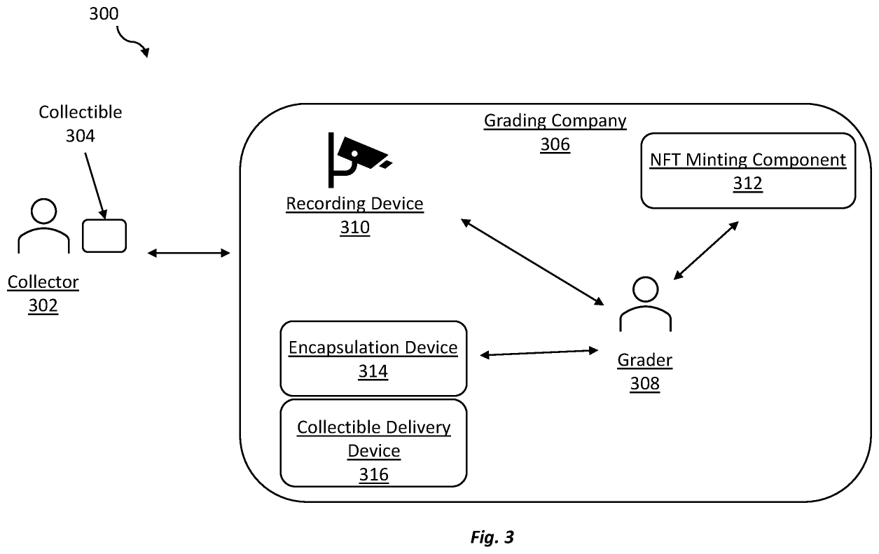

FIG. 3 depicts an exemplary system 300 for creating a non-fungible token associated with a collectible and grading of the collectible. The system 300 may include a collector 302, a collectible 304, a grading company 306, a grader 308, a recording device 310, a NFT minting component 312, an encapsulation device 314, and a collectible delivery device 316. In some embodiments there may be more or fewer components than those shown. The components depicted herein may be communicatively coupled to allow for the exchange of information amongst the components as necessitated by the functionality described herein. The system 300 may function similarly to the system described in FIG. 1.

In one embodiment of the system 300 depicted in FIG. 3, the system may comprise an audio-visual capture device, a non-fungible token minting device, an encapsulation device, and a collectible delivery device. The system may be configured to deliver the collectible to a grader that performs a grading procedure on the collectible, record the grader and collectible during the grading procedure, via the video recording device, and produce a video file. The system may mint a non-fungible token, via the non-fungible token minting device, based on the video file and associate the non-fungible token with the collectible, encapsulate the collectible via the encapsulation device, and deliver the collectible to a collectible owner via the collectible delivery device.

In some embodiments of the system the image file comprises a video stream, or a set of still images. Similarly, in some embodiments of the system the collectible may be a physical item, or a digital item.

In yet other embodiments, the system may be further configured to store, at a decentralized ledger, the image file associated with the non-fungible token. Alternatively, in some embodiments, the system may further comprise a server, wherein the server is configured to store the image file associated with the non-fungible token. Similarly, the non-fungible token may be stored on a decentralized ledger, or a server, as part of the minting process.

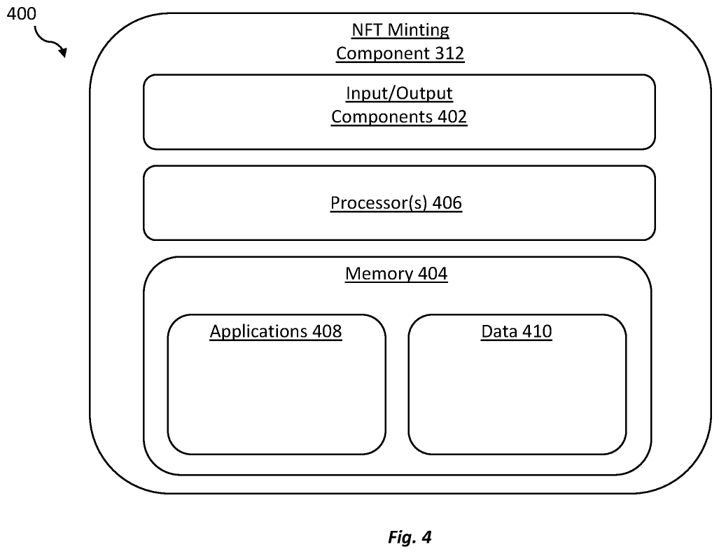

FIG. 4 depicts an exemplary non-fungible minting component 312 for creating a non-fungible token associated with a collectible and grading of the collectible. The non-fungible minting component 312 may include input/output components, memory 404, processors 406, applications 408, and data 410. The NFT minting component 312 may be configured to perform the functionality necessary for minting a NFT associated with the collectible as described herein.

FIG. 5 depicts an exemplary storage solution 116 for a non-fungible token associated with a collectible and grading of the collectible. The storage 116 may include a blockchain like data structure comprising blocks 502, 504, 506, 508, etc. that are linked to each other via reference data.

In some embodiments, the media file (e.g. image, video, audio, audio/visual) may be stored at the decentralized ledger based storage system 116. A user of the systems and methods described herein may access that media file via a hyperlink that points to the location that the media file is stored at. In other embodiments, the media file and associated metadata for the NFT may be stored at the decentralized ledger based storage system 116. In some embodiments, the decentralized ledger based storage system 116 may involve storing the data associated with the NFT and the grading process via a token based system that incentivizes participants in a decentralized ledger network to store other participants data as well as share data they store. In other embodiments, the decentralized ledger based storage system 116 may involve storing the data associated with the NFT and the grading process on a network that utilizes a content based routing system whereby participants in the network search for content and whatever nodes that participate in the network produce the content in response to the search.

In yet other embodiments, the decentralized ledger based storage system 116 may involve storing a hash of the data associated with the NFT and the grading process on a decentralized ledger based storage system that may be utilized by collectors, purchasers, and sellers of the collectible and associated NFT to verify that the content associated with the NFT and the grading process have not been tampered with. Similarly, the storage 116 of the data associated with the NFT and the grading process on a network that utilizes a decentralized ledger based storage system may involve storing chunks of the data at different locations in the network to distribute the storage location whereby those chunks of data have references to each other to allow a collector, purchaser, or seller to reassemble the data and verify its contents.

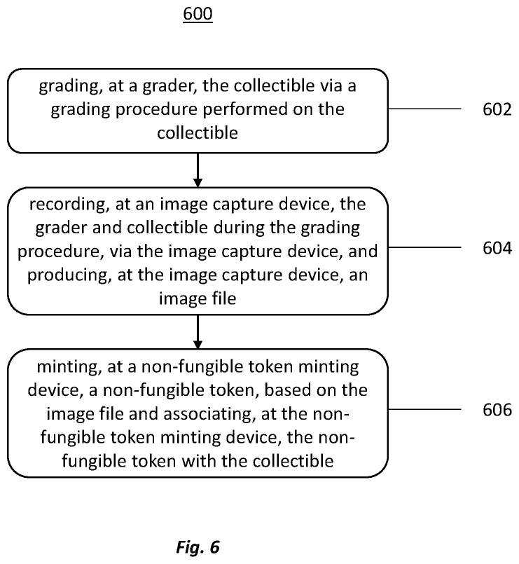

FIG. 6 depicts an exemplary method 600 for creating a non-fungible token associated with a collectible and grading of the collectible. The method 600 may utilize the components described herein and with reference to FIGS. 1-5. In some embodiments, the method 600 may comprise grading, at a grader, the collectible via a grading procedure performed on the collectible (block 602); recording, at an image capture device, the grader and collectible during the grading procedure, via the image capture device, and producing, at the image capture device, an image file (block 604); and minting, at a non-fungible token minting device, a non-fungible token, based on the image file and associating, at the non-fungible token minting device, the non-fungible token with the collectible (block 606). In some embodiments, there may be additional, or fewer, steps to the method.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirt and scope of the appended claims. For example. It is to be understood that the present technology contemplates that, to the extent possible, one or more features of any implementation can be combined with one or more features of any other implementation.

The methods and systems discussed herein may be implemented via one or more processing devices (e.g., a digital processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

The server(s) and client computing platform(s) may be communicatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s), client computing platform(s), and any other discussed third parties may be operatively linked via some other communication media.

A given client computing platform may include one or more processors configured to execute computer program modules. The computer program modules may be configured to enable a user associated with the given client computing platform to interface with the described systems and methods and/or provide other functionality attributed herein to client computing platform(s). By way of non-limiting example, the given client computing platform may include one or more of a desktop computer, a laptop computer, a handheld computer, a tablet computing platform, a Smartphone, a gaming console, a VR/AR headset or other device, a computing device that accesses a Metaverse where the NFT may or may not be viewable, and/or other computing platforms. A Metaverse may be a virtual world accessible to users via a VR/AR headset or other device, or some other computing device that allows a user to access and interact with digital items and digital communities. As part of the Metaverse a user may be able to view and interact with the NFT as it exists in relation to other digital items and digital communities.

Server(s) may include electronic storage and one or more processors, and/or other components. Server(s) may include communication lines, or ports to enable the exchange of information with a Network and/or other computing platforms. Illustration of server(s) is not intended to be limiting. Server(s) may include a plurality of hardware, software, and/or firmware components operating together to provide the functionality attributed herein to servicer(s). For example, server(s) may be implemented by a cloud of computing platforms operating together as server(s).

The electronic storage media may comprise non-transitory storage media that electronically stores information. The electronic storage media may include one or both of system storage that is provided integrally (i.e., substantially non-removable) with server(s) and/or removable storage that is removably connectable to server(s) via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private Network, and/or other virtual storage resources). The electronic storage may store software algorithms, information determined by processor(s), information received from server(s), information received from client computing platform(s), databases and/or other information that enables server(s) to function as described herein.

Processor(s) may be configured to provide information processing capabilities in server(s). As such, processor(s) may include one or more of a digital processors, an analog processor, a digital circuit designed to process information, an analog circuit designed to process information, a state machine, and/or other mechanisms for electronically processing information. Although processor(s) may function as a single entity, in other implementations, processor(s) may include a plurality of processing units. These processing units may be physically located within the same device, or processor(s) may represent processing functionality of a plurality of devices operating in coordination. Processor(s) may be configured to execute instructions for applications, or modules, by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The various messaging and data transfer described above may be accomplished with a REST API (or “RESTful” API). A RESTful API is an application program interface (API) that uses HTTP calls to request resources as opposed to functions. The function is embedded in the HTTP call through requests to GET, PUT, POST and DELETE, for example. The API spells out the proper way to request data, from an operating system or other application and allows management of customer data, sales orders, inventory, and products.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are in some embodiments directed to an improvement to computer functionality and may improve the functioning of conventional computers.

I claim:

1. A system for creating a non-fungible token associated with a collectible and grading of the collectible, the system comprising:
an image capture device; and
a non-fungible token minting device;
wherein the system is configured to:
receive a collectible and deliver the collectible to a grader that performs a grading procedure on the collectible;
record the grader during the grading procedure, via the image capture device, and produce an image file; and
mint a non-fungible token, via the non-fungible token minting device, based on the image file and associate the non-fungible token with the collectible.

2. The system of claim 1, wherein the image capture device is a video recording device.

3. The system of claim 2, wherein the image file comprises a video stream.

4. The system of claim 1, wherein the collectible is a physical item.

5. The system of claim 1, wherein the collectible is a digital item.

6. The system of claim 1, wherein the system is further configured to:
store, at a decentralized ledger, the image file associated with the non-fungible token.

7. The system of claim 1, further comprising:
a server, wherein the server is configured to store the image file associated with the non-fungible token.

8. The system of claim 1, wherein the non-fungible token is stored on a decentralized ledger as part of the minting process.

9. A method for creating a non-fungible token associated with a collectible and grading of the collectible, the method comprising:
grading, at a grader, the collectible via a grading procedure performed on the collectible;
recording, at an image capture device, the grader and collectible during the grading procedure, via the image capture device, and producing, at the image capture device, an image file; and
minting, at a non-fungible token minting device, a non-fungible token, based on the image file and associating, at the non-fungible token minting device, the non-fungible token with the collectible.

10. The method of claim 9, wherein the image capture device is a video recording device.

11. The method of claim 10, wherein the image file comprises a video file.

12. The method of claim 9, wherein the collectible is a digital item.

13. The method of claim 9, further comprising:
storing, at a decentralized ledger, the image file associated with the non-fungible token.

14. The method of claim 9, further comprising:
storing, at a server, the image file associated with the non-fungible token.

15. The method of claim 9, wherein minting further comprises:
storing, at a decentralized ledger, the non-fungible token as part of the minting process.

16. A system for creating a non-fungible token associated with a collectible and grading of the collectible, the system comprising:
an audio-visual capture device;
a non-fungible token minting device; and
an encapsulation device;
a collectible delivery device; and
wherein the system is configured to:
deliver the collectible to a grader that performs a grading procedure on the collectible;
record the grader and collectible during the grading procedure, via the video recording device, and produce a video file;
mint a non-fungible token, via the non-fungible token minting device, based on the video file and associate the non-fungible token with the collectible;
encapsulate the collectible via the encapsulation device; and
deliver the collectible to a collectible owner via the collectible delivery device.

17. The system of claim 16, wherein the image file comprises a video stream.

18. The system of claim 16, wherein the system is further configured to:
store, at a decentralized ledger, the image file associated with the non-fungible token.

19. The system of claim 16, further comprising:
a server, wherein the server is configured to store the image file associated with the non-fungible token.

20. The system of claim 16, wherein the non-fungible token is stored on a decentralized ledger as part of the minting process.
